(19) United States
(12) Patent Application Publication
(10) Pub. No.: US 2016/0084390 A1
(43) Pub. Date: Mar. 24, 2016

(54) MULTISTAGE FLOW CONTROL DEVICE AND METHOD OF CONTROLLING FLOW OF FLUID THROUGH A TUBULAR

(71) Applicants: Zhi Yong He, Cypress, TX (US); Carlos P. Izaguirre, Dayton, TX (US)

(72) Inventors: Zhi Yong He, Cypress, TX (US); Carlos P. Izaguirre, Dayton, TX (US)

(73) Assignee: Baker Hughes Incorporated, Houston, TX (US)

(21) Appl. No.: 14/489,796

(22) Filed: Sep. 18, 2014

(51) Int. Cl. F16K 11/065; G05D 7/01; F16K 31/12

(52) U.S. Cl. CPC F16K 11/0655; F16K 31/12; G05D 7/01

(57) ABSTRACT

A multistage flow control device includes, a tubular with a plurality of one or more openings, a plurality of seats positioned at the tubular, and a plurality of plugs that are movable relative to the tubular between at least a first position sealingly engaged with one of the plurality of seats and a second position displaced from the one of the plurality of seats. Each of the plurality of plugs is movable from the first position to the second position in response to a pressure differential applied thereacross achieving a threshold value with a first of the plurality of plugs moving at a first threshold value and a second of the plurality of plugs moving at a second threshold value.

### BACKGROUND

It is typical for flow control devices in tubular systems to employ valves that are spring loaded to a normally closed position. Such valves are configured to compress the spring when sufficient pressure differential is applied thereacross to open the valve and allow fluid to flow therethrough. Pressure upstream of these valves can drop quickly due to the sudden opening of a large flow-path through the valve which can result in the valve oscillating between open and closed depending upon whether flow through the valve is sufficient to prevent such oscillations. Preventing these undesirable oscillations can be difficult when the range of flow the flow control device must handle is wide. Those who practice in the field are therefore interested in new devices and methods to overcome the drawbacks associated with conventional devices.

### BRIEF DESCRIPTION

Disclosed herein is a multistage flow control device. The device includes, a tubular with a plurality of one or more openings, a plurality of seats positioned at the tubular, and a plurality of plugs that are movable relative to the tubular between at least a first position sealingly engaged with one of the plurality of seats and a second position displaced from the one of the plurality of seats. Each of the plurality of plugs is movable from the first position to the second position in response to a pressure differential applied thereacross achieving a threshold value with a first of the plurality of plugs moving at a first threshold value and a second of the plurality of plugs moving at a second threshold value.

Further disclosed herein is a method of controlling flow of fluid through a tubular. The method includes, building a pressure differential across a flow control device, moving a first plug at a first threshold value of the pressure differential, flowing fluid through a first one or more openings in the tubular, increasing the pressure differential across the flow control device, moving a second plug at a second threshold value of the pressure differential, and flowing fluid through the first one or more openings and a second one or more openings in the tubular.

### BRIEF DESCRIPTION OF THE DRAWINGS

The following descriptions should not be considered limiting in any way. With reference to the accompanying drawings, like elements are numbered alike:

FIG. 1 depicts a cross sectional view of a multistage flow control device disclosed herein;

FIG. 2 depicts a cross sectional view of the multistage flow control device of FIG. 1 in an alternate position;

FIG. 3 depicts a cross sectional view of the multistage flow control device of FIG. 1 in another alternate position; and

FIG. 4 depicts a cross sectional view of the multistage flow control device of FIG. 1 in yet another alternate position.

### DETAILED DESCRIPTION

A detailed description of one or more embodiments of the disclosed apparatus and method are presented herein by way of exemplification and not limitation with reference to the Figures.

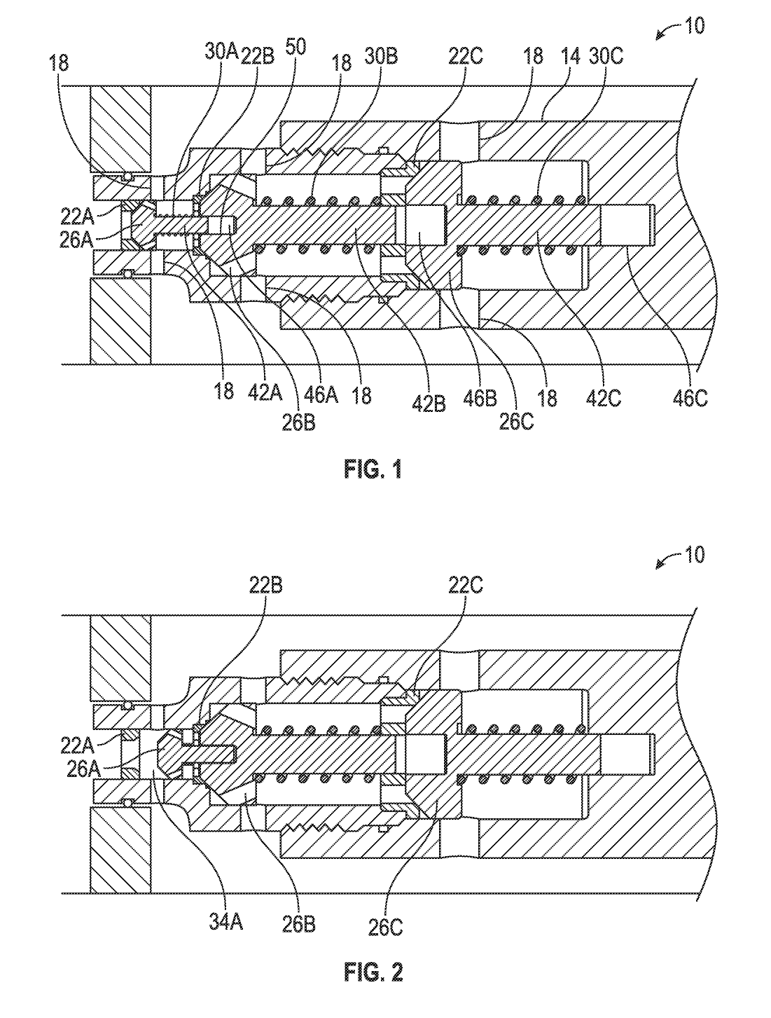

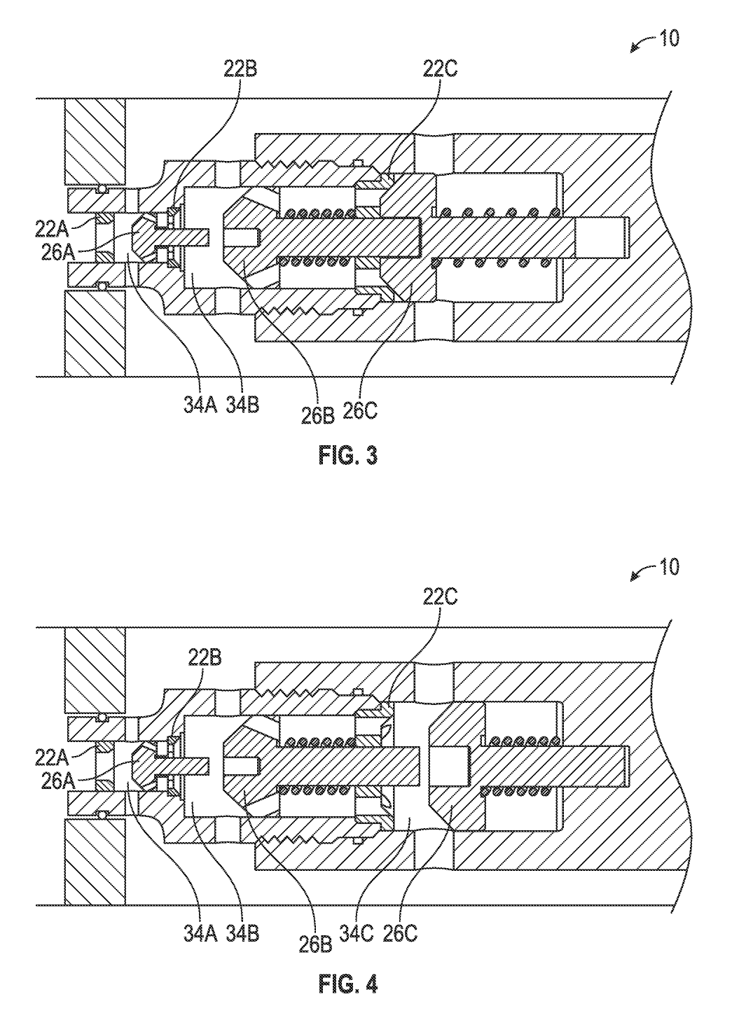

Referring to FIGS. 1-4, an embodiment of a multistage flow control device disclosed herein is illustrated at 10. The multistage flow control device 10 includes a tubular 14 with multiple stages of one or more openings 18A, 18B, 18C therethrough, a plurality of seats 22A, 22B, 22C attached to the tubular 14, and a plurality of plugs 26A, 26B, 26C, also referred to herein as darts, movable relative to the tubular 14. While the embodiment illustrated shows three of the stages of one or more openings 18A, 18B, 18C, three of the plurality of seats 22A, 22B, 22C, and three of the darts 26A, 26B and 26C, other embodiments could have more or few of each of these elements without deviating from the instant invention. The darts 26A, 26B, 26C are movable relative to the tubular 14 between at least a first position (also referred to as a closed position) sealingly engaged with one of the plurality of seats 22A, 22B, 22C and a second position (also referred to as an open position) displaced from the one of the plurality of seats 22A, 22B, 22C. In FIG. 1, all of the darts 26A, 26B, 26C are in the first position, in FIG. 2 the first dart 26A is in the second position while the darts 26B and 26C are in the first position, in FIG. 3 the darts 26A and 26B are in the second position while the third dart 26C is in the first position, and in FIG. 4 all three of the darts 26A, 26B and 26C are in the second position.

Each of the darts 26A, 26B, 26C is movable from the first position to the second position in response to a pressure differential applied thereacross achieving a threshold value. The first dart 26A has a first threshold value associated therewith, the second dart 26B has a second threshold value associated therewith, and the third dart 26C has a third threshold value associated therewith. Biasing members 30A, 30B and 30C (shown herein as compression springs) urge the darts 26A, 26B and 26C respectively in a direction that urges the darts 26A, 26B, 26C toward the first position. In one embodiment the openings 18A, 18B, 18C, the seats 22A, 22B, 22C, the darts 26A, 26B, 26 and the biasing members C30A, 30B, 30C are sized, positioned and configured such that the first threshold pressure is less than the second threshold pressure and the second threshold pressure is less than the third threshold pressure. As such, as pressure upstream of the device 10 increases beyond the first threshold pressure the first dart 26A will move to the second position thereby opening a flow-path 34A between the first dart 26A and the first seat 22A and allowing fluid flowing therethrough to flow out of the tubular 14 through the first stage of one or more openings 18A. Continued increases in pressure above the second threshold value cause the second dart 26B to move toward the second position thereby creating a second flow-path 34B between the second dart 26B and the second seat 22B and allowing fluid flowing therethrough to flow out of the tubular 14 through the second stage of one or more openings 18B. Still further continued increases in pressure above the third threshold value cause the third dart 26C to move toward the second position thereby creating a third flow-path 34C between the third dart 26C and the third seat 22C and allowing fluid flowing therethrough to flow out of the tubular 14 through the third stage of one or more openings 18C. It should be noted that when more than one of the darts 26A, 26B, 26C is in the second position the total flow area through the tubular 14 for fluid to flow out of the tubular 14 is the total area of all the openings 18A, 18B, 18C that are downstream of the darts 26A, 26B, 26C that are in the second position. The multistage flow control device 10 can be configured such that the first biasing member 30A is compressed to a solid height before the second dart 26B begins to move compressing the second biasing member 30B in the process. Similarly, the second biasing member 30B may need to be compressed solid before the third dart 26C begins to move compressing the third biasing member 30C in the process.

Further, the flow area defined by each of the stages of openings 18A, 18B, 18C can be set to selected values to allow for selected fluid flow at selected pressures. For example, the multistage flow control device 10 could be configured to allow about 0.01 gallons per minute flow through the first one or more openings 18A, 0.05 gallons per minute flow through the second one or more openings 18B and 0.10 gallons per minute through the third one or more openings 18C.

The device 10 also includes features to lessen generation of temporal pressure fluctuations during opening or closing of the openings 18A, 18B and 18C. In one embodiment a first stem 42A of the first dart 26A is positioned to move into a cavity 46A in the second dart 26B as the first dart 26A moves from the first position to the second position at least while the second dart 26B is in the first position. Any fluid within the first cavity 46A is forced out by the stem 42A entering the first cavity 46A. Sizing the first stem 42A to leave little clearance with walls 50 of the first cavity 46A creates a damping effect to movement of the stem 42A into the cavity 46A since the fluid must escape from the cavity 46A through the small clearance before the stem 42A can enter the cavity 46A. This damping slows movement of the dart 42A during opening of the flow-path 34A thereby lessening the amount of a pressure drop upstream of the first dart 26A associated with the opening. This effect also works in the opposite direction to decrease a rate of moving the dart 26A from the second position to the first position, thereby slowing a rate of closure of flow through the first openings 18A in the process. Stems 42B, 42C of the other darts can similarly by fitted to cavities 46B, 46C to slow movement of the darts 26B, 26C to lessen generation of temporal pressure fluctuations associated with their movements as well.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A multistage flow control device, comprising:
a tubular with a plurality of one or more openings;
a plurality of seats positioned at the tubular; and
a plurality of plugs being movable relative to the tubular between at least a first position sealingly engaged with one of the plurality of seats and a second position displaced from the one of the plurality of seats, each of the plurality of plugs being movable from the first position to the second position in response to a pressure differential applied thereacross achieving a threshold value with a first of the plurality of plugs moving at a first threshold value and a second of the plurality of plugs moving at a second threshold value.

2. The multistage flow control device of claim 1, further comprising a third of the plurality of plugs moving at a third threshold value.

3. The multistage flow control device of claim 1, further comprising a plurality of biasing members with each of the plurality of biasing members biasing one of the plurality of plugs toward the first position.

4. The multistage flow control device of claim 1, wherein flow through a first of the plurality of one or more openings is prevented by the first of the plurality of plugs being in the first position and flow through the first of the plurality of one or more openings is allowed when at least the first of the plurality plugs is in the second position.

5. The multistage flow control device of claim 4, wherein flow through a second of the plurality of one or more openings is prevented by the second of the plurality plugs being in the first position and flow through the second of the plurality of one or more openings is allowed when at least the first of the plurality plugs and the second of the plurality plugs are in the second position.

6. The multistage flow control device of claim 5, wherein flow through a first flow-path between the first of the plurality plugs and a first of the plurality of seats is flowable through either the first of the plurality of one or more openings or the second of the plurality of one or more openings when the first of the plurality plugs and the second of the plurality plugs are both in the second position.

7. The multistage flow control device of claim 1, wherein a stem of the first of the plurality plugs is locatable within a cavity when the firsts of the plurality plug is in the second position.

8. The multistage flow control device of claim 7, wherein the cavity is in the second of the plurality plugs.

9. The multistage flow control device of claim 7, wherein fluid is displaced from the cavity when the stem is located within the cavity.

10. The multistage flow control device of claim 9, wherein the stem and the cavity are sized to dampen movement of the stem into and out of the cavity by restricting fluid flow rates into and out of the cavity.

11. The multistage flow control device of claim 1, wherein flow area through each of the plurality of one or more openings of the multistage flow control device is controlled by the total area of flow of the plurality of one or more openings open to flow at a given pressure differential across the multistage flow control device.

12. A method of controlling flow of fluid through a tubular, comprising:
building pressure differential across a flow control device;
moving a first plug at a first threshold value of the pressure differential;
flowing fluid through a first one or more openings in the tubular;
increasing the pressure differential across the flow control device;
moving a second plug at a second threshold value of the pressure differential; and
flowing fluid through the first one or more openings and a second one or more openings in the tubular.

13. The method of controlling flow of fluid through a tubular of claim 12, further comprising:
increasing the pressure differential across the flow control device;
moving a third plug at a third threshold pressure value of the pressure differential; and
flowing fluid through the first one or more openings, the second one or more openings and a third one or more openings in the tubular.

14. The method of controlling flow of fluid through a tubular of claim 12, further comprising damping a rate of movement of the first plug.

15. The method of controlling flow of fluid through a tubular of claim 14, further comprising displacing fluid within a cavity with the moving of a stem of the first plug into the cavity.

16. The method of controlling flow of fluid through a tubular of claim 15, further comprising restricting a rate of flow of fluid from the cavity.

17. The method of controlling flow of fluid through a tubular of claim 14, further comprising biasing at least one of the first plug and the second plug in a direction against movement caused by the pressure differential reaching the first threshold value or the second threshold value.

18. The method of controlling flow of fluid through a tubular of claim 12, further comprising decreasing pressure differential across the flow control device and moving the first plug and the second plug back to their original positions.

19. The method of controlling flow of fluid through a tubular of claim 18, further comprising damping a rate of movement of the first plug back to its original position by restricting flow of fluid into a cavity in the second plug that a portion of the first plug evacuates as the first plug is moved back toward its original position.
